(19) United States
(12) Patent Application Publication
(10) Pub. No.: US 2004/0088062 A1
(43) Pub. Date: May 6, 2004

(54) Audio device and optical disk device

(75) Inventor: Takeyuki Minamimoto, Tachikawa-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/680,125

(22) Filed: Oct. 8, 2003

(30) Foreign Application Priority Data
Oct. 9, 2002 (JP) 2002-295628

(51) Int. Cl. G06F 17/00; G11B 7/085; G11B 21/08

(52) U.S. Cl. 700/94; 369/30.03

(57) ABSTRACT

There provided an audio device that includes, in its housing, an audio section outputting an identification signal, receiving an input signal, amplifying the input signal and output an output signal, and an optical disc device which, only when receiving an identification signal from the audio section, playing back the optical disc in response to an instruction signal, and, when not receiving the identification signal, does not play back the optical disc even if it receives the instruction signal. Thus, even if only the optical disc device is removed from the housing, connected to a PC and receives a read instruction signal, information in the optical disc cannot be illegally read.

### CROSS-REFERENCE TO RELATED APPLICATIONS

This application is based upon and claims the benefit of priority from the prior Japanese Patent Application No. 2002-295628, filed Oct. 9, 2002, the entire contents of which are incorporated herein by reference.

### BACKGROUND OF THE INVENTION

1. Field of the Invention

This invention relates to an optical disc device for recording information or playing back the same upon an optical disc such as CD (Compact Disc), CD (Compact Disc)-R (Recordable)/RW (ReWritable), DVD (Digital Versatile Disc)-ROM (Read Only Memory) or DVD (Digital Versatile Disc)-RAM (Random Access Memory), and an audio device including such optical disc device.

2. Description of the Related Art

An optical disc device is a device for reading data from an optical disc such as CD-ROM, CD-R, CD-RW, DVD-ROM or DVD-RAM and transferring the data to an exterior connection device (which will be referred to as a host hereinafter). This optical disc device includes a firmware separately customized so as to differently operate depending on different types of hosts. When the optical disc device is mounted in or connected to a personal computer (which will be referred to as PC hereinafter), a firmware customized for PC is mounted therein. When the optical disc device is mounted in an audio playback device, a firmware customized for audio playback device is mounted therein. Recently, there have been provided methods for changing and updating the firmwares mounted in such optical disc devices from hosts via interfaces.

Generally, the firmware is not customized with respect to basic operations including a read operation for an optical disc. Thus, conventional devices have problems. Namely, the conventional devices do not have measures to counter the case in which an optical disc device which includes therein a firmware for a host is connected to other host different from the corresponding host and operated, i.e., an optical disc device which includes a firmware for audio playback device therein is connected to a PC and operated in order to illegally copy contents information in an optical disc.

Accordingly, if an illegal user separates an optical disc device in which a firmware for audio playback device is mounted from the audio playback device, connects the optical disc device to a PC and then operates the same, the optical disc device cannot obtain identification information about the connecting host in order to identify the host.

Optical disc devices which do not have characteristics of the present invention cannot obtain host identification information. Thus, if an optical disc device which includes a firmware with a special function of being operated only for the specific host such as an audio playback device therein is connected to other host (e.g., PC), contents of an optical disc may be illegally copied.

### BRIEF SUMMARY OF THE INVENTION

In accordance with an embodiment of the present invention, there is provided an audio device which has an optical disc device and an audio section in its housing comprises an audio section outputting an identification signal, receiving an input signal, amplifying the input signal, and outputting an output signal; and an optical disc device playing back an optical disc in response to an instruction signal from the audio section in case of receiving the identification signal from the audio section, and playing back the optical disc even if receiving the instruction signal in case of not receiving the identification signal.

### BRIEF DESCRIPTION OF THE SEVERAL VIEWS OF THE DRAWING

FIG. 1 is a block structural view of an optical disc device connected to a PC (Personal Computer);

FIG. 2 is a block structural view of an optical disc device connected to an audio playback device;

FIG. 3 illustrates the basic block structure of the optical disc device connected to a host;

FIG. 4 is a processing flowchart of a host determination processing in the switched on optical disc device at the host (audio playback device) side;

FIG. 5 is a processing flowchart of the host determination processing in the switched on optical disc device at the optical disc device side;

FIG. 6 is a flowchart illustrating a processing performed after an optical disc is inserted into the optical disc device performing the host determination processing;

FIG. 7 is a block diagram of a representative desktop PC;

FIG. 8 is a block diagram of a representative notebook PC;

FIG. 9 is a flowchart illustrating a processing performed after the optical disc device is switched on;

FIG. 10 is a flowchart illustrating a processing performed after a read command is received from a host;

FIG. 11 is an exterior view of an embodiment of the audio device including the optical disc device of the present invention; and

FIG. 12 is a block diagram of an embodiment of the audio device including the optical disc device of the present invention.

### DETAILED DESCRIPTION OF THE INVENTION

Embodiments of the present invention will be described hereinafter based on the drawings.

(Audio Playback Device and Optical Disk Device Relating to the Present Invention)

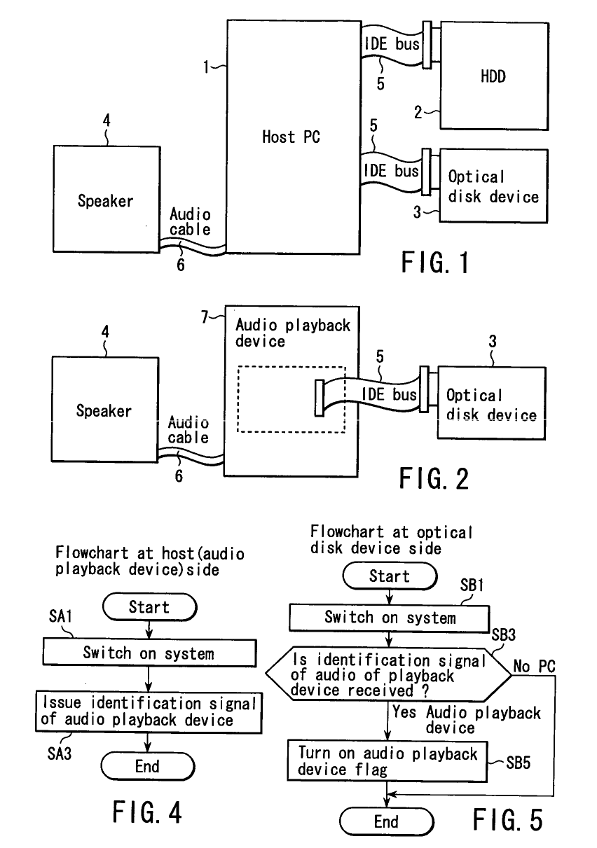

FIG. 1 is a block structural view of an optical disc device connected to a PC (personal computer). FIG. 2 is a block structural view of the optical disc device connected to an audio playback device.

Referring to FIG. 1, connected via IDE (ATA) buses 5 to a host PC 1 are a hard disc drive 2 (which will be referred to as a HDD hereinafter) which is capable of storing data and an optical disc device 3 in which a firmware customized for PC is mounted. A speaker 4 is connected via an audio cable 6 to the host PC 1. Such connected state is referred herein to as a host PC system. Referring to FIG. 2, the optical disc device 3 in which a firmware dedicated for audio playback device is mounted is connected via the IDE bus 5 to an audio playback device 7. The speaker 4 is connected via the audio cable 6 to the audio playback device 7. Such connected state is referred to herein as an audio playback device system.

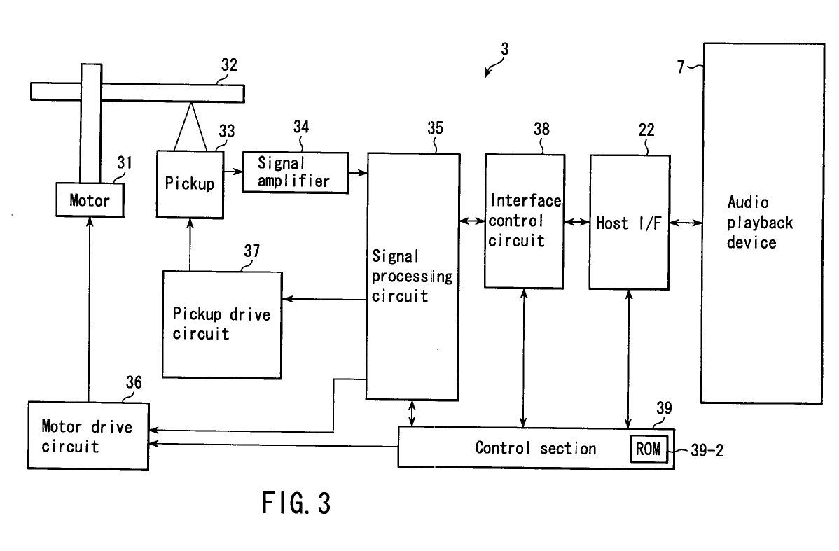

Next, the basic structure of the optical disc device 3 connected to the host will be described with reference to FIG. 3.

As shown in FIG. 3, the audio playback device 7 (or host PC 1) serving as a host has an interface 13 used for connection with the optical disc device, and is connected via the interface 13 to an interface 22 of the optical disc device 3.

The host 12 sends commands through the interface to the optical disc device 3. In response to such commands, the optical disc device 3 transfers data via the interface to the audio playback device 7 serving as a host, receives the data and writes the same into an optical disc. The optical disc device 3 can rotatably drive an optical disc 32 by a disc motor 31. Laser light from an optical pickup 33 is irradiated onto the optical disc 32, so that optical reading/writing of information are performed. A signal read by the optical pickup 33 is led to a signal amplification circuit 34 and amplified therein. The resultant amplified signal is inputted to a signal processing circuit 35. The signal processing circuit 35 performs a demodulation and separation processings upon a playback signal. Further, clock reproduction for processing data signals is also performed in the signal processing circuit 35.

A focus error signal, a tracking error signal and a motor drive signal are generated in the signal processing circuit 35. The motor drive signal is supplied to a motor drive circuit 36 to rotatably drive the disc motor 31. The focus error signal and the tracking error signal are inputted to a pickup drive circuit 37, and a focus control and a tracking control are performed by control signals from the pickup drive circuit 37.

Data reproduced in the signal processing circuit 35 is sent via an interface control circuit 38 to a host interface 22. A control section 39 serves as a CPU for control controls the overall optical disc device 3, and has a ROM 39-2 storing programs for carrying out predetermined operations shown in flowcharts.

In accordance with the audio playback device 7 relating to the present invention, as shown in FIGS. 11 and 12, the optical disc device 3 is accommodated within a housing for the audio playback device 7. For example, referring to FIG. 12, the audio device 7 includes an interface 61 connected to the optical disc device 3, an MPEG encoder/decoder 62 connected to the interface 61, an A/D converter 63 connected to the MPEG encoder/decoder 62 and an amplifier section 65 that outputs from the A/D converter 63 are supplied thereto. The outputs from the amplifier section 65 are supplied to the speaker section 4. Further, the audio playback device 7 has a hard disc drive 64 connected via data buses to the MPEG encoder/decoder 62 and the A/D converter 63 and a control section 66 for controlling the overall operation.

(Ripping Processing)

It is possible, in the structure shown in FIG. 1, to read audio digital data recorded in a CDDA (Compact Disc Digital Audio) by the optical disc device 3, and store the read data in the HDD 2 or convert the read data into compressed audio digital data (such as MP3) in the host PC 1 and then store the resultant converted data into the HDD 2. Such storage for the audio digital data is generally referred to as ripping. By such ripping, audio digital data can be illegally stored from a rented CDDA. Thus, companies distributing music suffer serious disadvantages.

In order to prevent ripping for the audio digital data, i.e., in order to protect copyrights, a CDDA against the standard which is produced so as to be accessed (be capable of researching tunes) by the audio playback device 7 which can play back only the CDDA (i.e., which does not include a highly functional optical disc device therein) but not to be normally accessed by a highly functional optical disc device which is mainly mounted in a PC and corresponds to various optical discs (e.g., CD-ROM, DVD-ROM and the like) is distributed. Examples of optical discs subjected to measures for ripping include Cactus Data Shield manufactured by Macrovision Corporation and KEY 2 Audio. Nevertheless, the present invention is not limited such discs. Any discs subjected to measures to counter illegal ripping may correspond to the present invention.

By changing a firmware to be mounted in a device so as to be capable of allowing the CDDA against the standard, such CDDA subjected to measures for ripping can be accessed even by the highly functional optical disc device and its data can be read.

A firmware which cannot be conventionally accessed is mounted in the optical disc device 3 which is connected to the host PC 1 which can perform ripping shown in FIG. 1. A firmware which is customized so as to be able to read the CDDA subjected to measures for ripping is mounted in the optical disc device 3 connected to the audio playback device 7 only for playback shown in FIG. 2. Thus, it is possible to protect copyrights, which is the intent to produce the CDDA subjected to measures for ripping.

In an optical disc device which does not have characteristics of the present invention, however, the connecting end of the optical disc device, i.e., the host thereof is not determined. Thus, such optical disc device does not have protecting measures against illegal users that remove the optical disc device 3 which can read the CDDA subjected to measures for ripping and is connected to the audio playback device 7 and connect the optical disc device 3 to the host PC 1 in order to perform ripping upon audio digital data.

(Processings of Audio Playback Device and Optical Disk Device of the Present Invention)

In accordance with the present invention, in order to protect the audio digital data from illegal users, a firmware performing a host determination processing is mounted in the optical disc device. When the audio playback device system is switched on, the audio playback device 7 serving as a host issues its identification signal. The identification signal is received by the optical disc device. In this way, the host determination processing is performed.

The host determination processing in the switched on optical disc device will be described by using flowcharts shown in FIGS. 4 and 5. FIG. 4 is a processing flowchart at the host (audio playback device) side. FIG. 5 is a processing flowchart at the optical disc device side.

For example, suppose the state of connecting optical disc device to the audio playback device 7 (i.e., the state shown in FIG. 2). Referring to FIG. 4, when the audio playback device system is switched on (the optical disc device is also switched on) (step SA1), the audio playback device 7 issues its identification signal to the optical disc device 3 (step SA3) and the processing ends. At the optical disc device, as shown in FIG. 5, when the audio playback device system is switched on step (SB1), it is determined whether or not the identification signal for the audio playback device 7 is received (step SB3). If it is determined that the identification signal is received (Y in step SB3), an audio playback device flag is on in an unillustrated memory within the CPU 39 for control and it is determined that the optical disc device is connected to the audio playback device 7 (step SB5). On the other hand, when the optical disc device 3 is switched on and does not receive the identification for the audio device (N in step SB3), it is determined that the optical disc device 3 is connected to the host PC1. Because the host PC1 does not issue its identification signal to the optical disc device, it is possible to determine whether the optical disc device is connected to the audio playback device 7 or to other hosts.

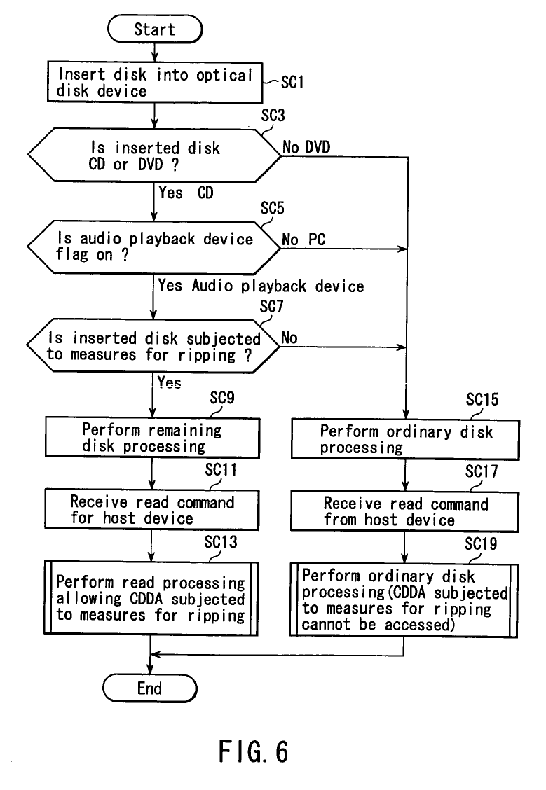

FIG. 6 is a flowchart illustrating a processing performed after an optical disc is inserted into the optical disc device performing the host determination processing.

When the optical disc 32 is inserted into the optical disc device (step SC1), the optical disc device performs a determination processing for the inserted optical disc 32. Specifically, it is determined whether the optical disc 32 is a CD or DVD by making reference to TOC (Table Of Content) data in the innermost periphery of the optical disc 32 or control data (step SC3). If it is determined in the processing that the optical disc 32 is a CD (Y in step SC3), the control CPU 39 in the optical disc device determines whether a flag is on. If the flag is on (Y in step SC5), the control CPU 39 recognizes that the optical disc device is connected to the audio playback device 7. If it is recognized that the optical disc device is connected to the audio playback device 7, it is determined whether or not the inserted CD is a disc subjected to measures for ripping (step SC7). If it is determined that the inserted CD is the CD subjected to measures for ripping (Y in step SC7), the remaining disc processing is performed (step SC9), and the optical disc device is in a waiting state until receiving a read command from the host (audio playback device 7). Whether or not the inserted disc is a disc subjected to measures for ripping may be determined by making reference to the TOC data. If the optical disc device receives the read command from the host, it receives the read command (step SC11) and performs a read processing in the case of the disc subjected to measures for ripping (step SC13). Namely, it is possible to perform the read processing even upon the CD subjected to measures for ripping.

If it is determined that the inserted disc is a DVD in the processing in step SC3 (N in step SC3), the process proceeds to a processing in step SC15. If the control CPU 39 determines in the processing in step SC5 that the flag is not on (N in step SC5), the control CPU 39 recognizes that the optical disc device is connected to a host other than the audio playback device 7, e.g., the host PC 1. The determination processing for the disc subjected to measures for ripping (step SC7) is not performed and instead the disc determination is performed upon the inserted optical disc 32 (step SC15). The processings in steps SC9 and SC15 are performed in order to confirm disc information required for the subsequent read operation. If it is determined in the processing in step SC7 that the disc is a CD but not a disc subjected to measures for ripping (step N in step SC7), the process proceeds to step SC15 and the disc determination is performed in step SC15.

The optical disc device waits for a read command from the host (host PC 1) and when the read command is provided from the host PC 1, it receives the read command (step SC 17). When receiving the read command, the optical disc device performs an ordinary read processing (step SC19). Even if the disc is a DVD (because a disc subjected to measures for ripping is usually a CD, in the case of DVD, an ordinary read processing is performed) or a CD but not a disc subjected to measures for ripping, the ordinary read processing is performed. It is configured herein that a disc subjected to measures for ripping (e.g., CDDA) cannot be accessed.

In accordance with the above-described embodiment, in an optical disc device which obtains host information and determines the host in order to determine whether or not functional operations of firmware are possible and thus can include only one firmware, operations that are different for various connecting ends serving as hosts can be performed. Thus, it is possible to protect the audio digital data against illegal users.

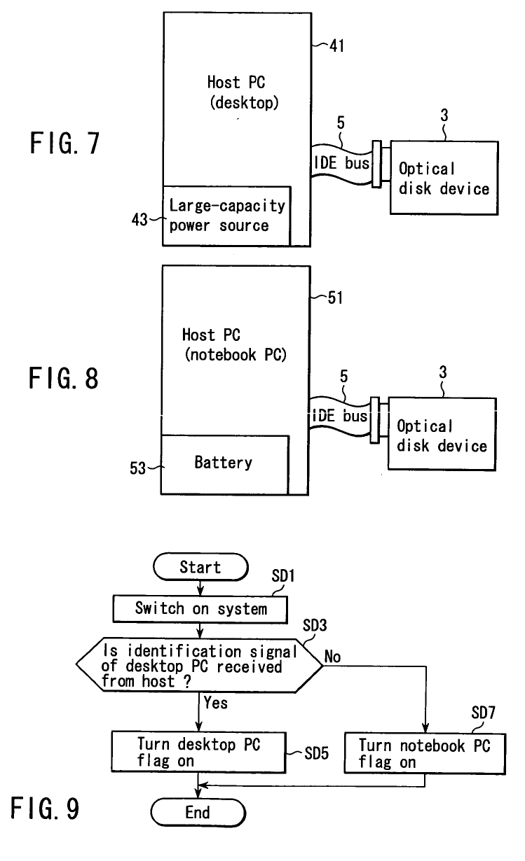

Next, a second embodiment of the present invention will be described based on FIGS. 7 through 10.

FIG. 7 illustrates a block diagram of a representative desktop PC. A host PC (desktop PC) 41 includes a large-capacity power source 43 therein. An optical disc device 47 which includes a firmware customized for desktop PC therein is connected via an IDE (ATA) bus 45 to the host PC 41. FIG. 8 illustrates a block diagram of a representative notebook PC. A host PC (notebook PC) 51 includes a battery 53 therein. An optical disc device 57 in which a firmware customized for notebook PC is mounted is connected via an IDE (ATA) bus 55 to the notebook PC 51.

Because the notebook PC 51 includes the battery 53 with a certain capacity therein and is weak against operational vibration of the optical disc device 57 because of its compactness, a firmware which performs a read operation at low speed is usually mounted in the optical disc device 57. Because the desktop PC 41 has a large-capacity power source is installed in a fixed manner, the operational vibration of the optical disc device 47 does not present problems. Thus, a firmware which performs a read operation at high speed is mounted in the optical disc device 47. Because a processing for obtaining information for the desktop PC41 and the notebook PC 51 is not included in optical disc devices which do not have the characteristics of the present invention, different firmwares must be prepared for the optical devices 47 and 57 and be managed not so as to be connected wrong hosts.

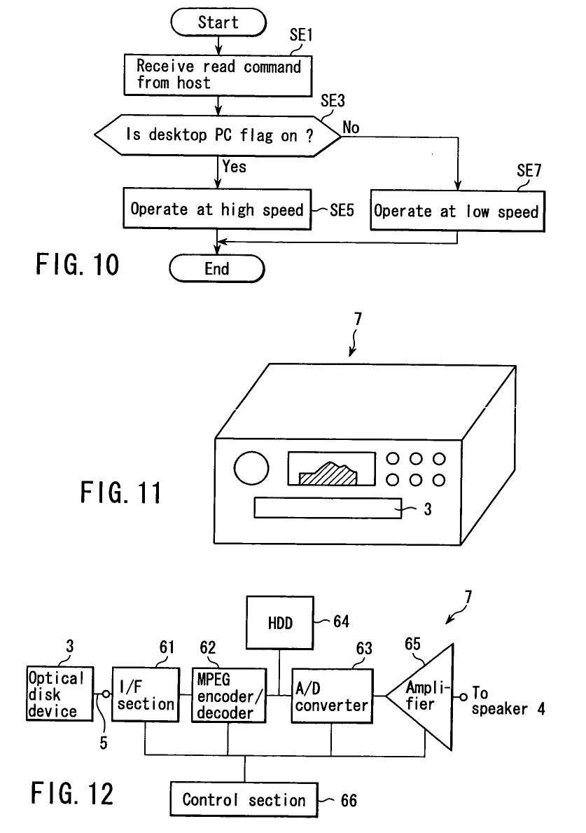

By mounting a firmware including a host determination processing of the present invention as shown in FIGS. 9 and 10 in the optical disc device, the same firmware can be used for the optical disc devices 47 and 57. FIG. 9 illustrates a flowchart of a processing performed after the optical disc device is switched on relating to the second embodiment. FIG. 10 illustrates a flowchart of a processing performed after a read command is received from a host.

For example, suppose the state of connecting the optical disc device 47 to the desktop PC 41 (i.e., the state shown in FIG. 7). Referring to FIG. 9, under this state, when the desktop PC 41 is switched on (step SD1), it is determined whether or not the optical disc device 47 receives an identification signal indicating the desktop PC 41 from the host (i.e., the desktop PC 41) (step SD3). If it is determined that the optical disc device 47 receives the identification signal indicating the desktop PC 41 (Y in step SD3), the CPU 39 for control turns a desktop PC flag on in an unillustrated memory (step SD5). If it is determined that the identification signal is not received (N in step SD3), a notebook PC flag is on in the memory (step SD7).

Referring to FIG. 10, when the optical disc device 47 receives a read command from the host (i.e., the desktop PC 41) (step SE1), the control CPU 39 determines whether or not the desktop PC flag is on in the memory (step SE3). If it is determined that the desktop PC flag is on (Y in step SE3), the control CPU 39 controls the motor drive circuit 36 so as to perform rotation at high speed and performs a read operation at high speed (step SES). If the control CPU 39 determines that the desktop PC flag is not on in the memory (N in step SE3), it controls the motor drive circuit 36 so as to carry out rotation at low speed and performs the read operation at low speed (step SE7).

Thus, firmwares need not to be prepared separately. Further, the optical disc device 47 which includes a firmware for desktop PC therein needs not to be managed not so as to be connected to the notebook PC 51 by mistake.

The present invention is not limited to the above-described embodiments, and may be varied, when being carried out, in various forms that fall within the principal of the present invention. For example, the present invention may be applied to, as well as optical disc devices, peripheral equipment for PC. For example, when the present invention is applied to HDDs, the present invention may be carried out in order to prevent that a HDD mounted in a HDD recorder is removed from the HDD recorder, connected to a PC and illegal copying is performed.

As described above, in accordance with the present invention, in an audio playback device with an optical disc device, the function for determining a host device is added in the optical disc device. Thus, even if an illegal user removes the optical disc device from the housing for the audio playback device, connects the optical disc device to a PC and applies a playback instruction signal, when an identification signal from the audio playback device is not provided, it is determined that the playback instruction signal is an illegal playback instruction signal from the illegal user and thus an optical disc is not played back. As a result, the contents of the optical disc can be protected.

Instead of a firmware customized for each of hosts, a firmware may be operated so as to correspond to different host devices. Thus, an optical disc device needs not to be managed not so as to be connected to a wrong host device.

What is claimed is:

1. An audio device which has an optical disc device and an audio section in its housing comprising:
an audio section outputting an identification signal, receiving an input signal, amplifying the input signal, and outputting an output signal; and
an optical disc device playing back an optical disc in response to an instruction signal from the audio section in case of receiving the identification signal from the audio section, and playing back the optical disc even if receiving the instruction signal in case of not receiving the identification signal.

2. The audio device according to claim 1, wherein the optical disc device comprises a receiving section which does not receive the identification signal from devices other than the audio section.

3. The audio device according to claim 1, wherein the optical disc device recognizes that a communicating end is the audio section by receiving the identification signal from the audio section.

4. The audio device according to claim 1, wherein the optical disc device determines whether the optical disc is an optical disc subjected to measures for ripping, if the optical disc device determines that the optical disc is the optical disc subjected to measures for ripping, only when receiving the identification signal from the audio section, it play back the optical disc subjected to measures for ripping in response to an instruction signal from the audio section, when not receiving the identification signal, it does not play back the optical disc subjected to measures for ripping even if receiving the instruction signal.

5. The audio device according to claim 1, wherein the optical disc device, when receiving the identification signal from the audio section, turns a flag on, when receiving the instruction signal, confirms that the flag is on and play back the optical disc, and if the flag is off, the optical disc device does not play back the optical disc even if receiving the instruction signal.

6. The audio device according to claim 1, wherein the optical disc device determines whether the optical disc is a CD or DVD, if it is determined that the optical disc is a CD, it is determined whether the CD is an optical disc subjected to measures for ripping, if it is determined that the CD is the optical disc subjected to measures for ripping, only when the optical disc device receives the identification signal from the audio section it plays back the optical disc subjected to measures for ripping in response to an instruction signal from the audio section, when it does not receive the identification signal, it does not play back the optical disc subjected to measures for ripping even if it receives the instruction signal.

7. An audio device which has an optical disc device and an audio section within its housing comprising:
an audio section including an output section which outputs an identification signal for informing that it is the audio section, and an amplification section which receives an input signal, amplifies the input signal and outputs an output signal; and
an optical disc device including a communication section which receives the identification signal from the output section of the audio section, and a processing section plays back an optical disc in response to an instruction signal from the audio section in case of the communication section receiving the identification signal, does not play back the optical disc even if it receives the instruction signal in case of the communication section not receiving the identification signal.

8. The audio device according to claim 7, wherein the communication section in the optical disc device does not receive the identification signal from devices other than the audio section.

9. The audio device according to claim 7, wherein the optical disc device further comprises an identification section for recognizing that the communicating end is the audio section by receiving the identification signal from the audio section.

10. The audio device according to claim 7, wherein the processing section of the optical disc device determines whether the optical disc is an optical disc subjected to measures for ripping, if it is determined that the optical disc is the disc subjected to measures for ripping, only when the processing section receives the identification signal from the audio section, it plays back the optical disc subjected to measures for ripping in response to an instruction signal from the audio section, when it does not receive the identification signal, it does not play back the optical disc subjected to measures for ripping even if it receives the instruction signal.

11. The audio device according to claim 7, wherein the processing section in the optical disc device turns a flag on when receiving the identification signal from the audio section, when receiving the instruction signal, it confirms that the flag is on and plays back the optical disc, if the flag is off, it does not play back the optical disc even if it receives the instruction signal.

12. The audio device according to claim 7, wherein the processing section in the optical disc device determines whether the optical disc is a CD or DVD, if it determines that the optical disc is the CD, it determines whether the CD is an optical disc subjected to measures for ripping, if it determines that the CD is the optical disc subjected to measures for ripping, only when receiving the identification signal from the audio section, it plays back processing upon the optical disc subjected to measures for ripping in response to an instruction signal from the audio section, when not receiving the identification signal, it does not play back the optical disc subjected to measures for ripping even if receiving the instruction signal, if it determines that the optical disc is the DVD, it does not determine whether the CD is the optical disc subjected to measures for ripping but play back the optical disc in response to the instruction signal.

13. An optical disc device comprising:
a communication section receiving an identification signal from an exterior audio device; and
a processing section playing back an optical disc in response to an instruction signal applied from the communication section in case of the communication section receiving the identification, and not playing back the optical disc even if it receives the instruction signal in case of the communication section not receiving the identification signal.

14. The audio device according to claim 13, wherein the communication section does not receive the identification signal from devices other than the audio device.

15. The audio device according to claim 13, wherein the processing section includes an identification section which receives the identification signal from the audio device to recognize that the communicating end is the audio device.

16. The audio device according to claim 13, wherein the processing section determines whether the optical disc is an optical disc subjected to measures for ripping, if it determines that the optical disc is the optical disc subjected to measures for ripping, only when receiving the identification signal from the audio device, it plays back the optical disc subjected to measures for ripping in response to an instruction signal from the audio device, when not receiving the identification signal, it does not play back the optical disc subjected to measures for ripping even if it receives the instruction signal.
